(19) United States
(12) Patent Application Publication
(10) Pub. No.: US 2025/0326691 A1
(43) Pub. Date: Oct. 23, 2025

(54) Gypsum Panel Having Enhanced Water Resistance

(71) Applicant: Gold Bond Building Products, LLC, Charlotte, NC (US)

(72) Inventors: Xing Yang, Charlotte, NC (US); Ratnasabapathy Gurunathan Iyer, Charlotte, NC (US)

(21) Appl. No.: 19/175,017

(22) Filed: Apr. 10, 2025

Related U.S. Application Data
(60) Provisional application No. 63/636,277, filed on Apr. 19, 2024.

(51) Int. Cl. C04B 28/14; B32B 9/00; B32B 9/06; C04B 22/10; C04B 24/42; C04B 103/65; C04B 111/00; C04B 111/27; E04C 2/04

(52) U.S. Cl. CPC C04B 28/14; B32B 9/005; B32B 9/06; C04B 22/10; C04B 22/106; C04B 24/42; E04C 2/043; B32B 2250/03; B32B 2250/40; B32B 2307/712; B32B 2607/00; C04B 2103/65; C04B 2111/0062; C04B 2111/27

(57) ABSTRACT

The present invention is directed to gypsum panels containing a water resistance enhancement composition and a method of making such gypsum panels. In one embodiment, the gypsum panel comprises a gypsum core, a first facing material, and a second facing material. Notably, the gypsum core may be formed by a gypsum slurry comprising a water resistance enhancement composition including an alkali salt, an ammonium salt, or a combination thereof. The methods of the present invention are directed to making the aforementioned gypsum panels.

### RELATED APPLICATIONS

The present application is based on and claims priority to U.S. Provisional Patent Application Ser. No. 63/636,277, filed on Apr. 19, 2024, which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum (i.e., stucco), water, and other conventional additives. The mixture is cast and allowed to set by reaction of the calcined gypsum with the water. During the production process, a variety of additives can be incorporated into the gypsum panel to enhance the physical and mechanical properties of the gypsum panel.

In general, various additives have been utilized to enhance the water resistance properties of gypsum panels. Notably, the inclusion of various additives may reduce or prevent water absorption and/or water ingress. However, it remains to be ascertained which compositions are particularly suitable for imparting water resistance characteristics and properties.

As a result, a need exists for providing a gypsum panel with improved water resistance properties.

### SUMMARY OF THE INVENTION

Aspects and advantages of the invention will be set forth in part in the following description, or may be obvious from the description, or may be learned through practice of the invention.

In accordance with one embodiment of the present invention, a gypsum panel is disclosed. The gypsum panel comprises: a gypsum core comprising gypsum, the gypsum core being formed by a gypsum slurry, the gypsum slurry comprising a water resistance enhancement composition and a siloxane composition, the water resistance enhancement composition being an alkali salt, an ammonium salt, or a combination thereof, the siloxane composition being a siloxane, wherein the weight ratio of the water resistance enhancement composition to the siloxane composition in the gypsum slurry is from about 40:1 to about 1:40; and a first facing material and a second facing material sandwiching the gypsum core.

In some aspects, the water resistance enhancement composition comprises the alkali salt, the alkali salt being an alkali carbonate, an alkali bicarbonate, or a combination thereof. In some aspects, the alkali salt comprises an alkali carbonate, wherein the alkali carbonate is sodium carbonate. In some aspects, the alkali salt comprises an alkali bicarbonate, wherein the alkali bicarbonate is sodium bicarbonate.

In some aspects, the water resistance enhancement composition comprises an ammonium salt. In some aspects, the ammonium salt is ammonium carbonate, ammonium bicarbonate, or a combination thereof.

In some aspects, the gypsum slurry has a pH of less than about 10, such as less than about 9.

In some aspects, the weight ratio of the water resistance enhancement composition to the siloxane composition in the gypsum slurry is from about 20:1 to about 1:20, such as from about 10:1 to about 1:5.

In some aspects, the gypsum panel exhibits a water absorption of less than about 10%, such as less than about 9%, such as less than about 8%, such as less than about 7%, such as less than about 6%. The water absorption of a gypsum panel may be measured via the Water Absorption Test and/or ASTM C473.

In some aspects, the water resistance enhancement composition is present in the gypsum slurry in an amount of 3 wt. % or less by weight of the gypsum slurry.

In some aspects, the gypsum slurry has a pH of less than about 9, the weight ratio of the water resistance enhancement composition to the siloxane composition in the gypsum slurry is from about 20:1 to about 1:20; and the water resistance enhancement composition is present in the gypsum slurry in an amount of 3 wt. % or less by weight of the gypsum slurry.

In accordance with one embodiment of the present invention, a gypsum panel is disclosed. The gypsum panel comprises: a gypsum core comprising gypsum; a siloxane composition, the siloxane composition being a siloxane; and a first facing material and a second facing material sandwiching the gypsum core; wherein a water resistance enhancement composition is present in or applied to a gypsum slurry, the first facing material, the second facing material, or a combination thereof during a process of making the gypsum panel, the water resistance enhancement composition being an alkali salt, an ammonium salt, or a combination thereof; wherein the weight ratio of the water resistance enhancement composition to the siloxane composition in the gypsum panel is from about 40:1 to about 1:40.

In some aspects, the water resistance enhancement composition comprises the alkali salt, the alkali salt being an alkali carbonate, an alkali bicarbonate, or a combination thereof. In some aspects, the alkali salt comprises an alkali carbonate, wherein the alkali carbonate is sodium carbonate. In some aspects, the alkali salt comprises an alkali bicarbonate, wherein the alkali bicarbonate is sodium bicarbonate.

In some aspects, the water resistance enhancement composition comprises an ammonium salt. In some aspects, the ammonium salt is ammonium carbonate, ammonium bicarbonate, or a combination thereof.

In some aspects, the gypsum slurry has a pH of less than about 10, such as less than about 9.

In accordance with one embodiment of the present invention, a method of making a gypsum panel is disclosed. The method comprises: providing a first facing material; depositing a gypsum slurry comprising stucco, water, a water resistance enhancement composition, and a siloxane composition onto the first facing material, the water resistance enhancement composition being an alkali salt, an ammonium salt, or a combination thereof, the weight ratio of the water resistance enhancement composition to the siloxane composition in the gypsum slurry being from about 40:1 to about 1:40; providing a second facing material on the gypsum slurry; and allowing the stucco to convert to calcium sulfate dihydrate.

In some aspects, the water resistance enhancement composition may be present in a gypsum slurry in an amount from about 0.001 wt. % to about 5 wt. % based on the weight of the stucco in the gypsum slurry, such as about 0.01 wt. % to about 3 wt. %, such as about 0.05 wt. % to about 2 wt. %.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel can include a gypsum core, one or more water resistance enhancement compositions, one or more siloxane compositions, and/or one or more facing materials. In this regard, the gypsum core can include gypsum (i.e., calcium sulfate dihydrate), a water resistance enhancement composition, a siloxane composition, and may include other optional additives. The present inventors have discovered that the gypsum panel disclosed herein can have various benefits due to the use of a water resistance enhancement composition, particularly a water resistance enhancement composition containing one or more alkali salts and/or one or more ammonium salts. For instance, the gypsum panel disclosed herein may include a gypsum core that has a lower pH and/or enhanced water resistance when compared to traditional water resistant gypsum panels.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

It should be understood that any concentration values disclosed herein may refer to mass concentration, molar concentration, number concentration, or volume concentration.

It should be understood that, unless stated otherwise, any standard listed herein (e.g., ASTM) is the most recent version available as of the latest revision year. Further, it should be understood that throughout the entirety of this specification, the term “and/or” refers to one or all of the listed components or a combination of any two or more of the listed components.

Notably, some aspects of the present disclosure may omit one or more of the features disclosed herein.

In general, the gypsum core may comprise calcium sulfate dihydrate. The gypsum used to make the gypsum core may be from a natural source, a synthetic source, and/or from reclaim and is thus not necessarily limited by the present invention. In general, the gypsum, in particular the calcium sulfate dihydrate, may be present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum may be present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In some aspects, the gypsum core may also comprise other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

In some aspects, the gypsum core may include components from a reclaim facing material, such as paper fibers or glass fibers from a reclaim facing material.

Generally, a gypsum panel formed in accordance with the present disclosure may have a water resistance enhancement composition and/or a siloxane composition applied (e.g., sprayed) to and/or incorporated in any component of a gypsum panel (e.g., a gypsum core, a gypsum core layer, a facing material, a gypsum slurry) at any time of the process disclosed herein, including during, before, and/or after any of the process steps disclosed herein. Notably, a water resistance enhancement composition and/or a siloxane composition may be incorporated in one or more gypsum slurries (e.g., a first gypsum slurry, a second gypsum slurry, a third gypsum slurry) and/or one or more gypsum core layers (e.g., a first gypsum core layer, a second gypsum core layer, a third gypsum core layer). Generally, a water resistance enhancement composition and/or a siloxane composition may be present between the first facing material and the gypsum slurry and/or gypsum core and/or may be present between the second facing material and the gypsum slurry and/or gypsum core.

Notably, a water resistance enhancement composition applied to and/or incorporated in a component of a gypsum panel may be the same as or different than a water resistance enhancement composition applied to and/or incorporated in a different component of a gypsum panel. For instance, a water resistance enhancement composition incorporated in a first gypsum core layer may be the same as or different than a water resistance enhancement composition incorporated in a third gypsum core layer.

In some aspects, a water resistance enhancement composition and/or a siloxane composition may be incorporated in and/or applied to one or more facing materials (e.g., first facing material, second facing material). Generally, the method of application of a water resistance enhancement composition and/or a siloxane composition is not limited by the present disclosure and may include any method of application known in the art. In general, a water resistance enhancement composition and/or a siloxane composition may be applied by spraying (e.g., misting), brushing, curtain coating, and/or roll coating. Notably, a water resistance enhancement composition and/or a siloxane composition may be incorporated in and/or applied to the first facing material, the gypsum slurry, the second facing material, or a combination thereof. In one aspect, a water resistance enhancement composition and/or a siloxane composition may be incorporated in and/or applied to at least a portion of a surface of a first facing material and/or at least a portion of a surface of a second facing material that is adjacent to the gypsum slurry and/or gypsum core (i.e., the gypsum slurry and/or gypsum core facing surface of the first facing material, the gypsum slurry and/or gypsum core facing surface of the second facing material) before the gypsum slurry is deposited, provided, or contacted with the first facing material and/or before the second facing material is provided on or contacted with the gypsum slurry respectively. In another aspect, a water resistance enhancement composition and/or a siloxane composition may be incorporated in and/or applied to the gypsum slurry before the second facing material is provided on or contacted with the gypsum slurry. In this respect, a water resistance enhancement composition and/or a siloxane composition may be incorporated in and/or applied to at least a portion of the gypsum slurry adjacent the second facing material before the second facing material is provided on or contacted with the gypsum slurry. Additionally, in yet another aspect, a water resistance enhancement composition and/or a siloxane composition may be incorporated in and/or applied to the gypsum slurry before the second facing material is provided on or contacted with the gypsum slurry and may be incorporated in and/or applied to at least a portion of the surface of the second facing material that is adjacent the gypsum slurry (i.e., the gypsum slurry facing surface of the second facing material) before the second facing material is provided on or contacted with the gypsum slurry.

As previously disclosed herein, a water resistance enhancement composition and/or a siloxane composition may be applied to one or more facing materials on a surface or side of a facing material (e.g., first facing material, second facing material) adjacent to a gypsum slurry and/or gypsum core. In general, a water resistance enhancement composition and/or a siloxane composition may be applied to one or more facing materials on a surface or side of a facing material (e.g., first facing material, second facing material) opposite a gypsum slurry and/or gypsum core. In this respect, a water resistance enhancement composition and/or a siloxane composition may be applied to one or more facing materials on the outward facing surface of one or more facing materials.

In general, a water resistance enhancement composition and/or a siloxane composition may be incorporated in and/or applied to one or more facing materials (e.g., first facing material, second facing material) during the manufacturing process of the gypsum panel and/or in an offline process. When incorporated and/or applied in an offline process, a water resistance enhancement composition and/or a siloxane composition may be applied to a facing material (e.g., first facing material, second facing material) before the facing material is utilized in the manufacturing process of the gypsum panel.

Notably, a gypsum slurry or gypsum panel and/or any component thereof formed in accordance with the present disclosure may include a water resistance enhancement composition, a siloxane composition, or a combination thereof. In general, a water resistance enhancement composition may include one or more alkali salts (e.g., one or more alkali carbonates, one or more alkali bicarbonates), one or more ammonium salts (e.g., ammonium carbonate, ammonium bicarbonate), one or more borates (e.g., a sodium borate, such as borax), or a combination thereof. Notably, an alkali carbonate may be sodium carbonate, lithium carbonate, potassium carbonate, cesium carbonate, or more generally any alkali carbonate. Notably, an alkali bicarbonate may be sodium bicarbonate. Generally, the use one or more alkali carbonates may be advantageous in that they may act as a set retarder. The one or more alkali carbonates (e.g., sodium carbonate, sodium bicarbonate) may retard or slow the reaction of water and stucco.

In general, a siloxane composition may include one or more siloxanes, such as methyl hydrogen siloxane (i.e., polymethylhydrogensiloxane).

Generally, a gypsum slurry or gypsum panel formed in accordance with the present disclosure may include one or more compositions disclosed in U.S. Patent Publication No. 2018/0345532, which is incorporated herein by reference in its entirety.

Generally, the one or siloxanes of a siloxane composition may include a polyorganosiloxane. Notably, silicon-bonded organic groups of the siloxane may contain monovalent hydrocarbon and/or monovalent halogenated hydrocarbon groups. Such monovalent groups may have from 1 to about 20 carbon atoms, preferably from 1 to 10 carbon atoms, and are exemplified by, but not limited to, alkyl (e.g., methyl, ethyl, propyl, pentyl, octyl, undecyl, and octadecyl); cycloalkyl (e.g., cyclohexyl); alkenyl (e.g., vinyl, allyl, butenyl, and hexenyl); aryl (e.g., phenyl, tolyl, xylyl, benzyl, and 2-phenylethyl); and halogenated hydrocarbon groups (e.g., 3,3,3-trifluoropropyl, 3-chloropropyl, and dichlorophenyl). In general, at least 30%, such as at least 40%, such as about 50% of the organic groups are methyl.

In general, a siloxane may have the following general formula (II):

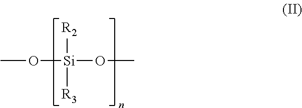

wherein,
n is an integer greater than 1; and
R₂ and R₅ are independently hydrogen, halogen, alkyl, cycloalkyl, aryl, heteroaryl, haloalkyl, haloaryl, alkoxy, carboxyalkyl, or alkenyl.

As indicated above, n is an integer greater than 1. In this regard, n may be 1 or more, such as 2 or more, such as 5 or more, such as 10 or more, such as 20 or more, such as 30 or more, such as 50 or more, such as 100 or more. In addition, n may be 500 or less, such as 400 or less, such as 300 or less, such as 200 or less, such as 150 or less, such as 125 or less, such as 100 or less, such as 80 or less, such as 60 or less, such as 50 or less, such as 40 or less, such as 30 or less.

As indicated above, R₂ and R₅ are independently hydrogen, halogen, alkyl, cycloalkyl, aryl, heteroaryl, haloalkyl, haloaryl, alkoxy, carboxyalkyl, or alkenyl. For instance, R₂ and Rs may independently be a monovalent group typically containing from 1 to about 20 carbon atoms. The alkyl groups may be methyl, ethyl, propyl, pentyl, octyl, undecyl, octadecyl, etc. The alkoxy groups may be methoxy, ethoxy, propoxy, etc. The carboxyalkyl groups may be acetyl, etc. The cycloalkyl groups may be cyclohexyl, cyclooctyl, etc. The alkenyl groups may be vinyl, allyl, butenyl, hexenyl, etc. The aryl groups may be phenyl, tolyl, xylyl, benzyl, 2-phenylethyl, etc. The halogenated hydrocarbon groups may be 3,3,3-trifluoropropyl, 3-chloropropyl, dichlorophenyl, etc.

In one embodiment, at least one of R₂ and Rs is hydrogen. In another embodiment, only one of R₂ and Rs is hydrogen. In a further embodiment, at least one of R₂ and R₃ is alkyl. For instance, the alkyl may have 1 or more, such as 2 or more, such as 3 or more carbon atoms. The alkyl may have 20 or less, such as 16 or less, such as 12 or less, such as 10 or less, such as 8 or less, such as 6 or less, such as 4 or less, such as 2 or less carbon atoms. In one particular embodiment, only one of R₂ and Rs is alkyl. In general, in one particular embodiment, the alkyl may be methyl.

Examples of one or more siloxanes that may be utilized in a siloxane composition, such as polyorganosiloxanes, may include polydimethylsiloxane (“PDMS”), polymethylhydrogensiloxane, dimethyidiphenylpolysiloxane, dimethyl/methylphenylpolysiloxane, polymethylphenylsiloxane, methylphenyl/dimethylsiloxane, vinyldimethyl terminated polydimethylsiloxane, vinylmethyl/dimethylpolysiloxane, vinyldimethyl terminated vinylmethyl/dimethylpolysiloxane, divinylmethyl terminated polydimethylsiloxane, vinylphenylmethyl terminated polydimethylsiloxane, dimethylhydro terminated polydimethylsiloxane, methylhydro/dimethylpolysiloxane, methylhydro terminated methyloctylpolysiloxane, methylhydro/phenylmethyl polysiloxane, fluoro-modified polysiloxane, etc., or a mixture thereof. In one embodiment, a siloxane, such as the polyorganosiloxane, may be polydimethylsiloxane. In another embodiment, a siloxane, such as the polyorganosiloxane, may be polymethylhydrogensiloxane.

Notably, an organopolysiloxane may also contain one more pendant and/or terminal polar functional groups, such as hydroxyl, epoxy, carboxyl, amino, alkoxy, methacrylic, or mercapto groups, which impart some degree of hydrophilicity to the polymer. For example, an organopolysiloxane may contain at least one hydroxy group, and optionally an average of at least two silicon-bonded hydroxy groups (silanol groups) per molecule. Examples of such organopolysiloxanes may include, for instance, dihydroxypolydimethylsiloxane, hydroxy-trimethylsiloxypolydimethylsiloxane, etc. Alkoxy-modified organopolysiloxanes may also be employed, such as dimethoxypolydimethylsiloxane, methoxy-trimethylsiloxypolydimethylsiloxane, diethoxypolydimethylsiloxane, ethoxy-trimethylsiloxy-polydimethylsiloxane, etc. Notably, other suitable organopolysiloxanes are those modified with at least one amino functional group. Examples of such amino-functional polysiloxanes may include, for instance, diamino-functional polydimethylsiloxanes.

Generally, one or more siloxanes may have a relatively high molecular weight. For example, a siloxane may have a molecular weight of about 500 g/mol or more, such as about 1,000 g/mol or more, such as about 1,500 g/mol or more, such as about 2,000 g/mol or more, such as about 3,000 g/mol or more, such as about 4,000 g/mol or more, such as about 5,000 g/mol or more, such as about 10,000 g/mol or more, such as about 25,000 g/mol or more. In general, a siloxane may have a molecular weight of about 500,000 g/mol or less, such as about 400,000 g/mol or less, such as about 300,000 g/mol or less, such as about 200,000 g/mol or less, such as about 150,000 g/mol or less, such as about 100,000 g/mol or less, such as about 50,000 g/mol or less, such as about 20,000 g/mol or less, such as about 10,000 g/mol or less, such as about 5,000 g/mol or less, such as about 4,000 g/mol or less, such as about 3,000 g/mol or less. Such molecular weight may be the molecular weight of the siloxane as provided to the gypsum slurry.

In some aspects, the weight ratio of a water resistance enhancement composition to a siloxane composition in a gypsum panel and/or any component thereof (e.g., a gypsum core) may be from about 40:1 to about 1:40, including all incremental ratios therebetween. For instance, the weight ratio of a water resistance enhancement composition to a siloxane composition in a gypsum panel and/or any component thereof may be about 40:1 or less, such as about 35:1 or less, such as about 30:1 or less, such as about 25:1 or less, such as about 20:1 or less, such as about 15:1 or less, such as about 10:1 or less, such as about 5:1 or less, such as about 4:1 or less, such as about 3:1 or less, such as about 2:1 or less, such as about 1:1 or less, such as about 1:2 or less, such as about 1:3 or less, such as about 1:4 or less, such as about 1:5 or less, such as about 1:10 or less, such as about 1:15 or less, such as about 1:20 or less, such as about 1:25 or less, such as about 1:30 or less, such as about 1:35 or less. In general, the weight ratio of a water resistance enhancement composition to a siloxane composition in a gypsum panel and/or any component thereof may be about 1:40 or more, such as about 1:35 or more, such as about 1:30 or more, such as about 1:25 or more, such as about 1:20 or more, such as about 1:15 or more, such as about 1:10 or more, such as about 1:5 or more, such as about 1:4 or more, such as about 1:3 or more, such as about 1:2 or more, such as about 1:1 or more, such as about 2:1 or more, such as about 3:1 or more, such as about 4:1 or more, such as about 5:1 or more, such as about 10:1 or more, such as about 15:1 or more, such as about 20:1 or more, such as about 25:1 or more, such as about 30:1 or more, such as about 35:1 or more. Notably, the aforementioned values may also be the weight ratio of a water resistance enhancement composition to a siloxane composition in a gypsum slurry. In this respect, the weight ratio of a water resistance enhancement composition to a siloxane composition in a gypsum slurry may be from about 40:1 to about 1:40, including all incremental ratios therebetween.

In some aspects, the weight ratio of one or more alkali salts (e.g., one or more alkali carbonates, one or more alkali bicarbonates) and/or one or more ammonium salts (e.g., ammonium carbonate, ammonium bicarbonate) to a siloxane (e.g., methyl hydrogen siloxane) in a gypsum panel and/or any component thereof (e.g., a gypsum core) may be from about 40:1 to about 1:40, including all incremental ratios therebetween. For instance, the weight ratio of one or more alkali salts and/or one or more ammonium salts to a siloxane in a gypsum panel and/or any component thereof may be about 40:1 or less, such as about 35:1 or less, such as about 30:1 or less, such as about 25:1 or less, such as about 20:1 or less, such as about 15:1 or less, such as about 10:1 or less, such as about 5:1 or less, such as about 4:1 or less, such as about 3:1 or less, such as about 2:1 or less, such as about 1:1 or less, such as about 1:2 or less, such as about 1:3 or less, such as about 1:4 or less, such as about 1:5 or less, such as about 1:10 or less, such as about 1:15 or less, such as about 1:20 or less, such as about 1:25 or less, such as about 1:30 or less, such as about 1:35 or less. In general, the weight ratio of one or more alkali salts and/or one or more ammonium salts to a siloxane in a gypsum panel and/or any component thereof may be about 1:40 or more, such as about 1:35 or more, such as about 1:30 or more, such as about 1:25 or more, such as about 1:20 or more, such as about 1:15 or more, such as about 1:10 or more, such as about 1:5 or more, such as about 1:4 or more, such as about 1:3 or more, such as about 1:2 or more, such as about 1:1 or more, such as about 2:1 or more, such as about 3:1 or more, such as about 4:1 or more, such as about 5:1 or more, such as about 10:1 or more, such as about 15:1 or more, such as about 20:1 or more, such as about 25:1 or more, such as about 30:1 or more, such as about 35:1 or more. Notably, the aforementioned values may also be the weight ratio of one or more alkali salts (e.g., one or more alkali carbonates, one or more alkali bicarbonates) and/or one or more ammonium salts (e.g., ammonium carbonate, ammonium bicarbonate) to a siloxane (e.g., methyl hydrogen siloxane) in a gypsum slurry. In this respect, the weight ratio of one or more alkali salts (e.g., one or more alkali carbonates, one or more alkali bicarbonates) and/or one or more ammonium salts (e.g., ammonium carbonate, ammonium bicarbonate) to a siloxane (e.g., methyl hydrogen siloxane) in a gypsum slurry may be from about 40:1 to about 1:40, including all incremental ratios therebetween.

Notably, the incorporation and/or application of a water resistance enhancement composition in and/or to a gypsum panel may result in enhanced water resistance while also resulting in a gypsum core and/or gypsum slurry having a pH lower than the gypsum cores and/or gypsum slurries of traditional water resistant gypsum panels. Traditionally, self-crosslinking silicone monomers have been added to gypsum slurries to attain water repellency in gypsum panels. In general, the crosslinking of a silicone monomer may be catalyzed by higher pH, which may be obtained through the addition of basic compounds such as Portland cement, siliconates, and/or alkali/alkaline metal hydroxides. In this respect, cross-linking efficiency may be increased as pH is increased. However, a gypsum core and/or gypsum slurry having an increased pH may have various drawbacks. Notably, the gypsum panel of the present disclosure may comprise a gypsum core having a reduced pH, which may be particularly advantageous. In this respect, the gypsum slurry utilized to form the gypsum core may have a reduced pH, which may be particularly advantageous. For instance, a reduced pH may reduce the corrosion of metal components that contact the gypsum panel, such as fasteners (e.g., nails), metal studs, and/or metal framing. Additionally, a reduced pH may extend the durability of a gypsum panel to moisture, which may decrease the degradation of a gypsum panel over time. Further, a reduced pH may benefit the preservation and/or efficiency of other additives included in the gypsum panel, such as fire resistance additives. Additionally, a reduced pH may also reduce gypsum panel production issues.

In general, the pH of a gypsum slurry utilized to form a gypsum core of a gypsum panel in accordance with the present disclosure may be measured with a pH meter, such as an Extech PH100 ExStik pH Waterproof Meter. The pH may be measured after a period of time from one second to one minute, including all increments of one second therebetween, after all of the components of the gypsum slurry are combined. For instance, the pH may be measured thirty-five seconds after all of the components of the gypsum slurry are combined. In general, a gypsum core and/or gypsum slurry containing a water resistance enhancement composition in accordance with the present disclosure may have a pH from about 6 to about 11, such as about 6 or more, such as about 7 or more, such as about 8 or more, such as about 9 or more, such as about 10 or more, such as about 11 or less, such as about 10 or less, such as about 9 or less, such as about 8 or less, such as about 7 or less. In a preferred embodiment, the gypsum slurry has a pH of about 9 or less. It should be understood that the above pH values, including any ranges thereof, may be the pH of the gypsum core.

In general, a water resistance enhancement composition may comprise a liquid (e.g., one or more surfactants, one or more dispersants, one or more retarders, one or more alcohols, and/or water). Additionally, in one aspect, the water resistance enhancement composition may include an accelerator, such as one or more of the accelerators described in U.S. Pat. No. 9,878,950, which is incorporated herein by reference in its entirety.

Generally, a water resistance enhancement composition and/or any component thereof may be in the form of a solid (e.g., powder, fines, granules), a liquid, or a mixture thereof. In general, a water resistance enhancement composition and/or any component thereof may be applied to and/or incorporated in any component of a gypsum slurry or gypsum panel in the form of a solid, a liquid (e.g., a solution), or a mixture (e.g., a dispersion) thereof. As used herein, the term “dispersion” refers to a liquid having solid particles dispersed therein. In some aspects, the liquid of a dispersion may be water and the solid particles of the dispersion may be one or more alkali salts and/or one or more ammonium salts. In general, the water resistance enhancement composition may be applied and/or incorporated as a dry application, a wet application, or a combination thereof. As used herein, a “dry application” of a water resistance enhancement composition refers to the application and/or incorporation of a water resistance enhancement composition that does not comprise a liquid. As used herein, a “wet application” of a water resistance enhancement composition refers to the application and/or incorporation of a water resistance enhancement composition that comprises a liquid.

Generally, a siloxane composition may be in the form of a solid (e.g., powder, fines, granules), a liquid, or a mixture thereof. In general, a siloxane composition may be applied to and/or incorporated in any component of a gypsum slurry or gypsum panel in the form of a solid, a liquid (e.g., a solution), or a mixture (e.g., a dispersion) thereof. In general, the siloxane composition may be applied and/or incorporated as a dry application, a wet application, or a combination thereof. As used herein, a “dry application” of a siloxane composition refers to the application and/or incorporation of a siloxane composition that does not comprise a liquid. As used herein, a “wet application” of a siloxane composition refers to the application and/or incorporation of a siloxane composition that comprises a liquid.

Generally, a water resistance enhancement composition and/or any component thereof may undergo mixing in a shear mixer, such as a Quadro® Liquids high shear mixer, a pin mixer, or an Axiflow® high shear mixer, at any time of the process disclosed herein, including during, before, and/or after any of the process steps disclosed herein. In general, a shear mixer may combine a liquid (e.g., one or more surfactants, one or more dispersants, one or more retarders, one or more alcohols, and/or water) with a water resistance enhancement composition and/or any component thereof. In one aspect, the combination of a liquid and a water resistance enhancement composition and/or any component thereof in a shear mixer may form a dispersion. In this respect, in one aspect, the water resistance enhancement composition and/or any component thereof may form the solid portion of a dispersion. In some aspects, a water resistance enhancement composition and/or any component thereof may be mixed or combined prior to being mixed in a shear mixer. In this respect, in one aspect, a water resistance enhancement composition and/or any component thereof may undergo one or more mixing processes. Notably, a shear mixer may continuously mix a liquid with a water resistance enhancement composition and/or any component thereof. After the shear mixer has mixed a liquid with a water resistance enhancement composition and/or any component thereof, the resulting water resistance enhancement composition, which may be in the form of a dispersion, may be applied (e.g., sprayed) to and/or incorporated in a facing material and/or a gypsum slurry.

A surface of a facing material (e.g., first facing material, second facing material) adjacent to a gypsum slurry and/or gypsum core may include a water resistance enhancement composition and/or any component thereof applied to and/or present on at least a portion of the surface of the facing material adjacent to a gypsum slurry and/or gypsum core. For instance, a water resistance enhancement composition and/or any component thereof may be applied to and/or be present on the surface of a facing material adjacent to a gypsum slurry and/or gypsum core in an amount of about 1% or more of the surface area of the surface of the facing material, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less, such as about 5% or less of the surface area of the surface of the facing material.

A surface of a facing material (e.g., first facing material, second facing material) opposite a gypsum slurry and/or gypsum core may include a water resistance enhancement composition and/or any component thereof applied to and/or present on at least a portion of the surface of the facing material opposite a gypsum slurry and/or gypsum core. For instance, a water resistance enhancement composition and/or any component thereof may be applied to and/or be present on the surface of a facing material opposite a gypsum slurry and/or gypsum core in an amount of about 1% or more of the surface area of the surface of the facing material, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less, such as about 5% or less of the surface area of the surface of the facing material.

The application of a water resistance enhancement composition may result in the penetration and/or embedment of a water resistance enhancement composition and/or any component thereof in one or more of the facing materials (e.g., first facing material, second facing material). Notably, the penetration and/or embedment of a water resistance enhancement composition and/or any component thereof may result in improved water resistance characteristics and properties. Generally, if the water resistance enhancement composition is applied via spraying, the intensity and/or angle of the spraying and the distance of the spraying mechanism to the facing material may affect the depth of penetration of the water resistance enhancement composition and/or any component thereof.

Generally, a water resistance enhancement composition and/or any component thereof may penetrate at least a portion of the thickness of a respective facing material (e.g., first facing material, second facing material). Notably, the water resistance enhancement composition and/or any component thereof may penetrate or be present in a respective facing material (e.g., first facing material, second facing material) by about 0% to about 100% of the thickness of the respective facing material, such as about 0% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less.

Generally, when a water resistance enhancement composition is applied to a facing material, the longer the water resistance enhancement composition and/or any component thereof is in fluid contact with a facing material, the deeper the penetration of the water resistance enhancement composition and/or any component thereof. Notably, a water resistance enhancement composition and/or any component thereof may be in fluid contact with a facing material for a period of about 1 second to about 30 seconds, including all increments of 1 second therebetween. For instance, a water resistance enhancement composition and/or any component thereof may be in fluid contact with a facing material for about 1 second or more, such as about 5 seconds or more, such as about 10 seconds or more, such as about 15 seconds or more, such as about 20 seconds or more, such as about 25 seconds or more, such as about 30 seconds or less, such as about 25 seconds or less, such as about 20 seconds or less, such as about 15 seconds or less, such as about 10 seconds or less, such as about 5 seconds or less. In this respect, a water resistance enhancement composition and/or any component thereof may be in fluid contact with a facing material for a period of about 1 second to about 30 seconds, including all increments of 1 second therebetween, until a gypsum slurry contacts or is provided on a respective facing material.

A surface of a facing material (e.g., first facing material, second facing material) adjacent to a gypsum slurry and/or gypsum core may include a siloxane composition applied to and/or present on at least a portion of the surface of the facing material adjacent to a gypsum slurry and/or gypsum core. For instance, a siloxane composition may be applied to and/or be present on the surface of a facing material adjacent to a gypsum slurry and/or gypsum core in an amount of about 1% or more of the surface area of the surface of the facing material, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less, such as about 5% or less of the surface area of the surface of the facing material.

A surface of a facing material (e.g., first facing material, second facing material) opposite a gypsum slurry and/or gypsum core may include a siloxane composition applied to and/or present on at least a portion of the surface of the facing material opposite a gypsum slurry and/or gypsum core. For instance, a siloxane composition may be applied to and/or be present on the surface of a facing material opposite a gypsum slurry and/or gypsum core in an amount of about 1% or more of the surface area of the surface of the facing material, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less, such as about 5% or less of the surface area of the surface of the facing material.

The application of a siloxane composition may result in the penetration and/or embedment of a siloxane composition in one or more of the facing materials (e.g., first facing material, second facing material). Notably, the penetration and/or embedment of a siloxane composition may result in improved water resistance characteristics and properties.

Generally, a siloxane composition may penetrate at least a portion of the thickness of a respective facing material (e.g., first facing material, second facing material). Notably, a siloxane composition may penetrate a respective facing material (e.g., first facing material, second facing material) by about 0% to about 100% of the thickness of the respective facing material, such as about 0% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less.

In general, a water resistance enhancement composition may be present in and/or applied to the gypsum panel in an amount of 0.001 lbs/MSF to 125 lbs/MSF, including all increments of 0.001 lbs/MSF therebetween. For instance, a water resistance enhancement composition may be present in and/or applied to the gypsum panel in an amount of 0.001 lbs/MSF or more, such as 0.01 lbs/MSF or more, such as 0.05 lbs/MSF or more, such as 0.1 lb/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 10 lbs/MSF or more, such as 50 lbs/MSF or more, such as 100 lbs/MSF or more. Generally, a water resistance enhancement composition may be present in and/or applied to the gypsum panel in an amount of 125 lbs/MSF or less, such as 100 lbs/MSF or less, such as 50 lbs/MSF or less, such as 25 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

Further, a water resistance enhancement composition may be present in and/or applied to a gypsum slurry or a gypsum panel and/or any component thereof in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more, such as 5 wt. % or more, such as 8 wt. % or more, such as 10 wt. % or more, such as 12 wt. % or more. Generally, a water resistance enhancement composition may be present in and/or applied to a gypsum slurry or a gypsum panel and/or any component thereof in an amount of 15 wt. % or less, such as 12 wt. % or less, such as 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.30 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

As previously disclosed, a water resistance enhancement composition may comprise one or more alkali salts, one or more ammonium salts, one or more borates (e.g., sodium borate), or a combination thereof. For instance, one or more alkali salts (e.g., one or more alkali carbonates, one or more alkali bicarbonates) one or more ammonium salts (e.g., ammonium carbonate, ammonium bicarbonate), one or more borates (e.g., sodium borate), or a combination thereof may be present in a water resistance enhancement composition in an amount from about 0.01 wt. % to about 100 wt. %, including all increments of 0.01 wt. % therebetween. In this respect, one or more alkali salts, one or more ammonium salts, one or more borates, or a combination thereof may be present in a water resistance enhancement composition in an amount of about 0.01 wt. % or more, such as about 1 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 60 wt. % or more, such as about 70 wt. % or more, such as about 80 wt. % or more, such as about 90 wt. % or more, such as about 100 wt. % or less, such as about 90 wt. % or less, such as about 80 wt. % or less, such as about 70 wt. % or less, such as about 60 wt. % or less, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 10 wt. % or less, such as about 5 wt. % or less, such as about 1 wt. % or less.

In some aspects, one or more alkali salts (e.g., one or more alkali carbonates, one or more alkali bicarbonates) one or more ammonium salts (e.g., ammonium carbonate, ammonium bicarbonate), one or more borates (e.g., sodium borate), or a combination thereof may be present in a water resistance enhancement composition in an amount from about 1 wt. % to about 100 wt. %, such as from about 20 wt. % to about 100 wt. %, such as from about 40 wt. % to about 100 wt. %, such as from about 50 wt. % to about 100 wt. %.

Generally, a water resistance enhancement composition may comprise gypsum and/or stucco. For instance, gypsum and/or stucco may be present in a water resistance enhancement composition in an amount from about 0.01 wt. % to about 99.99 wt. %, including all increments of 0.01 wt. % therebetween. In this respect, gypsum and/or stucco may be present in a water resistance enhancement composition in an amount of about 0.01 wt. % or more, such as about 1 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 60 wt. % or more, such as about 70 wt. % or more, such as about 80 wt. % or more, such as about 90 wt. % or more, such as about 99.99 wt. % or less, such as about 90 wt. % or less, such as about 80 wt. % or less, such as about 70 wt. % or less, such as about 60 wt. % or less, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 10 wt. % or less, such as about 5 wt. % or less, such as about 1 wt. % or less.

As previously disclosed, a water resistance enhancement composition may comprise a liquid (e.g., one or more surfactants, one or more dispersants, one or more retarders, one or more alcohols, and/or water). For instance, a liquid may be present in a water resistance enhancement composition in an amount from about 0 wt. % to about 99.99 wt. %, including all increments of 0.01 wt. % therebetween. In this respect, a liquid (e.g., one or more surfactants, one or more dispersants, one or more retarders, one or more alcohols, and/or water) may be present in a water resistance enhancement composition in an amount of about 0 wt. % or more, such as about 10 wt. % or more, such as about 20 wt. % or more, such as about 30 wt. % or more, such as about 40 wt. % or more, such as about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more, such as about 99.99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less, such as about 50 wt. % or less, such as about 40 wt. % or less, such as about 30 wt. % or less, such as about 20 wt. % or less, such as about 10 wt. % or less.

In order to provide the desired effect, the water resistance enhancement composition and/or any component thereof may have a particular average particle size. For instance, the water resistance enhancement composition and/or any component thereof may have an average particle size of 3 mm or less, such as 2.5 mm or less, such as 2 mm or less, such as 1.5 mm or less, such as 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 150 microns or less, such as 100 microns or less, such as 80 microns or less, such as 75 microns or less, such as 50 microns or less, such as 40 microns or less, such as 25 microns or less, such as 20 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. The water resistance enhancement composition and/or any component thereof may have an average particle size of 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 25 microns or more, such as 40 microns or more, such as 50 microns or more, such as 75 microns or more, such as 80 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1000 microns or more, such as 1.5 mm or more, such as 2 mm or more, such as 2.5 mm or more. Furthermore, in one aspect, the aforementioned values may refer to a median particle size of the water resistance enhancement composition and/or any component thereof. In this respect, the water resistance enhancement composition and/or any component thereof may have a D10, D50, D90, and/or D97 of any of the values previously disclosed, including any incremental values therebetween.

Notably, in one aspect, the aforementioned values may refer to the agglomerate size of the water resistance enhancement composition and/or any component thereof. In one aspect, the aforementioned values may refer to the agglomerate size and the particle size of the water resistance enhancement composition and/or any component thereof. In this respect, the aforementioned values may refer to the combined average and/or combined median size of the agglomerates (i.e., particle agglomerates) and the individual particles of the water resistance enhancement composition and/or any component thereof. For instance, if a water resistance enhancement composition contains 30 wt. % agglomerates and 70 wt. % individual particles, all of the sizes of the agglomerates and the individual particles may be analyzed to determine an average and/or median of the combined agglomerates and individual particles.

Generally, the water resistance enhancement composition and/or any component thereof may have a particular particle size distribution. The particle size distribution of the water resistance enhancement composition and/or any component thereof may be monomodal, bi-modal, or multi-modal.

In general, a siloxane composition may be present in the gypsum panel in an amount of 0.001 lbs/MSF to about 125 lbs/MSF, including all increments of 0.001 lbs/MSF therebetween. For instance, a siloxane composition may be present in the gypsum panel in an amount of 0.001 lbs/MSF or more, such as 0.01 lbs/MSF or more, such as 0.05 lbs/MSF or more, such as 0.1 lb/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 10 lbs/MSF or more, such as 50 lbs/MSF or more, such as 100 lbs/MSF or more. Generally, a siloxane composition may be present in the gypsum panel in an amount of 125 lbs/MSF or less, such as 100 lbs/MSF or less, such as 50 lbs/MSF or less, such as 25 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

Further, a siloxane composition may be present in and/or applied to a gypsum slurry or a gypsum panel and/or any component thereof in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more, such as 5 wt. % or more, such as 8 wt. % or more, such as 10 wt. % or more, such as 12 wt. % or more. Generally, a siloxane composition may be present in and/or applied to a gypsum slurry or a gypsum panel and/or any component thereof in an amount of 15 wt. % or less, such as 12 wt. % or less, such as 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.30 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

Generally, the water resistance enhancement composition and/or siloxane composition may be heterogeneously or nonuniformly dispersed in the gypsum core. In one aspect, the concentration of the water resistance enhancement composition and/or siloxane composition may be such that a concentration gradient of the water resistance enhancement composition and/or siloxane composition is formed in a gypsum core. In some aspects, the concentration gradient may be such that the concentration of the water resistance enhancement composition and/or siloxane composition increases or decreases over a portion of the thickness, such as a thickness disclosed herein, of a gypsum core formed in accordance with the present disclosure. In one aspect, a gypsum core formed in accordance with the present disclosure may have a higher concentration of the water resistance enhancement composition and/or siloxane composition in the portion of the gypsum core adjacent to the first facing material (e.g., the first gypsum core layer) with the concentration of the water resistance enhancement composition and/or siloxane composition decreasing across a dimension (e.g., the thickness) of the gypsum core. In general, in one aspect, the concentration of the water resistance enhancement composition and/or siloxane composition in the gypsum core may decrease across a thickness of a gypsum core beginning at the portion of the gypsum core adjacent the first facing material and ending at the portion of the gypsum core adjacent the second facing material or ending at the center of the thickness of the gypsum core. It should be understood that the center of the thickness of the gypsum core is parallel to one or more respective facing materials and is a plane that extends the length and width of the gypsum core. It should be understood that any concentration values disclosed herein may refer to mass concentration, molar concentration, number concentration, or volume concentration.

In one aspect, a gypsum core formed in accordance with the present disclosure may have a higher concentration of the water resistance enhancement composition and/or siloxane composition in the portion of the gypsum core adjacent to the second facing material (e.g., the third gypsum core layer) with the concentration of the water resistance enhancement composition and/or siloxane composition decreasing across a dimension (e.g., the thickness) of the gypsum core. In general, in one aspect, the concentration of the water resistance enhancement composition and/or siloxane composition in the gypsum core may decrease across the thickness of a gypsum core beginning at the portion of the gypsum core adjacent the second facing material and ending at the portion of the gypsum core adjacent the first facing material.

In one aspect, a gypsum core (e.g., set gypsum core) formed in accordance with the present disclosure may have a higher concentration of the water resistance enhancement composition and/or siloxane composition in the portion of the gypsum core adjacent to the first facing material as compared to the concentration of the water resistance enhancement composition and/or siloxane composition in the portion of the gypsum core adjacent to the second facing material. In this respect, the concentration of the water resistance enhancement composition and/or siloxane composition in the portion of the gypsum core adjacent to the first facing material may be higher than the concentration of the water resistance enhancement composition and/or siloxane composition in the portion of the gypsum core adjacent to the second facing material. As used herein, a “set gypsum core” refers to the gypsum core after the drying process of the gypsum panel, which may include drying the gypsum panel in a heating or drying device (e.g., kiln). In another aspect, a gypsum core (e.g., set gypsum core) formed in accordance with the present disclosure may have a higher concentration of the water resistance enhancement composition and/or siloxane composition in the portion of the gypsum core adjacent to the second facing material as compared to the concentration of the water resistance enhancement composition and/or siloxane composition in the portion of the gypsum core adjacent to the first facing material. In this respect, the concentration of the water resistance enhancement composition and/or siloxane composition in the portion of the gypsum core adjacent to the second facing material may be higher than the concentration of the water resistance enhancement composition and/or siloxane composition in the portion of the gypsum core adjacent to the first facing material.

In yet another aspect, the concentration of the water resistance enhancement composition and/or siloxane composition in the gypsum core (e.g., set gypsum core) may be higher in the portions of the gypsum core adjacent to the respective facing materials. For instance, the concentration of the water resistance enhancement composition and/or siloxane composition in the gypsum core may be higher in the portions of the gypsum core adjacent the first facing material and the second facing material, as compared to the center of the thickness of the gypsum core. In one aspect, a gypsum core formed in accordance with the present disclosure may have a higher concentration of the water resistance enhancement composition and/or siloxane composition adjacent to the first facing material and the second facing material with the concentration of the water resistance enhancement composition and/or siloxane composition decreasing toward the center of the thickness of the gypsum core beginning at the portions of the gypsum core adjacent the first facing material and second facing material respectively.

Notably, in one aspect, the three highest concentrations of the water resistance enhancement composition and/or siloxane composition in a gypsum core (e.g., set gypsum core) may be at the portion of the gypsum core adjacent the first facing material, at the center of the thickness of the gypsum core, and at the portion of the gypsum core adjacent the second facing material respectively. In this respect, the area of a gypsum core between the portion of the gypsum core adjacent the first facing material and the center of the thickness of the gypsum core may have a reduced concentration of the water resistance enhancement composition and/or siloxane composition compared to the concentration of the water resistance enhancement composition and/or siloxane composition in the portion of the gypsum core adjacent the first facing material and the center of the thickness of the gypsum core. Further, the area of a gypsum core between the portion of the gypsum core adjacent the second facing material and the center of the thickness of the gypsum core may have a reduced concentration of the water resistance enhancement composition and/or siloxane composition compared to the concentration of the water resistance enhancement composition and/or siloxane composition in the portion of the gypsum core adjacent the second facing material and the center of the thickness of the gypsum core.

Notably, it should be understood that a portion of a gypsum core may refer to a portion of a thickness of a gypsum core, such as 1/32 inches or more, such as 1/16 inches or more, such as 1/12 inches or more, such as ⅛ inches or more, such as ¼ inches or more. In this respect, in some aspects, a portion of a gypsum core adjacent to a facing material may be 1/12 inches or more. It should be understood that a portion of a gypsum core may refer to a portion of a thickness of a gypsum core, such as ½ inches or less, such as ¼ inches or less, such as ⅛ inches or less, such as 1/12 inches or less, such as 1/16 inches or less. In this respect, in some aspects, a portion of a gypsum core adjacent to a facing material may be ½ inches or less.

Further, it should be understood that the portion of the gypsum core adjacent to the first facing material may be referred to as the first gypsum core layer. Additionally, when the gypsum core includes two gypsum core layers, the portion of the gypsum core adjacent to the second facing material may be referred to as the second gypsum core layer. Further, when the gypsum core includes three gypsum core layers, the portion of the gypsum core adjacent to the second facing material may be referred to as the third gypsum core layer.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In some aspects, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, a gypsum panel formed in accordance with the present disclosure may be formed from a method as disclosed herein. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry is not necessarily limited and may be any generally known in the art. Generally, in one embodiment, the gypsum core is made from a gypsum slurry including at least stucco, water, and a water resistance enhancement composition.

In general, stucco may be referred to as calcined gypsum or calcium sulfate hemihydrate. The calcined gypsum may be from a natural source, a synthetic source, and/or from reclaim and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., AII, AIII), α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may include water. Water may be employed for fluidity and also for rehydration of the gypsum to allow for setting.

The weight ratio of the water to the stucco may be 0.1 or more, such as 0.2 or more, such as 0.2 or more, such as 0.3 or more, such as 0.4 or more, such as 0.5 or more, such as 0.6 or more, such as 0.7 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

In one aspect, the foaming agent may include one or more foam stabilizers, such as ethoxylated glycerin. The one or more foam stabilizers may be present in the gypsum slurry and/or gypsum core in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less by weight of the foaming agent. The one or more foam stabilizers may be present in the gypsum slurry and/or gypsum core in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more by weight of the foaming agent.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In some aspects, the gypsum slurry, gypsum core, and/or water resistance enhancement composition may include a dispersant. The dispersant is not necessarily limited and may include any that can be utilized within the gypsum slurry. The dispersant may include carboxylates, sulfates, sulfonates, phosphates, mixtures thereof, etc.

In one embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate. In one embodiment, the phosphate may be sodium monofluorophosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In some aspects, the gypsum slurry, gypsum core, and/or water resistance enhancement composition may include one or more surfactants. In general, the surfactant may be an anionic surfactant, a cationic surfactant, a non-ionic surfactant, a fluorinated surfactant, a silicon surfactant, or a mixture thereof. Generally, a surfactant may be in the form of a solid, a liquid, or a combination thereof.

As indicated above, in one embodiment, the surfactant may include an anionic surfactant. In general, anionic surfactants include those having one or more negatively charged functional groups. For instance, the anionic surfactant may include an alkali metal or ammonium salts of alkyl, aryl or alkylaryl sulfonates, sulfates, or a mixture thereof. In some aspects, the anionic surfactant may include ammonium lauryl sulfate, sodium lauryl sulfate, sodium octylphenol glycolether sulfate, sodium laureth sulfate, sodium myreth sulfate, sodium dodecylbenzene sulfonate, perfluorobutane sulfonate, dodecyl benzene sulfonate, alpha-olefin sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate, and mixtures thereof. Other examples include a C8-C22 alkyl fatty acid salt of an alkali metal, alkaline earth metal, ammonium, alkyl substituted ammonium, for example, isopropylamine salt, or alkanolammonium salt, a C8-C22 alkyl fatty acid ester, a C8-C22 alkyl fatty acid ester salt, and alkyl ether carboxylates. Further, the anionic surfactant may include a phosphate (alkyl-aryl ether phosphates, alkyl ether phosphates, etc.), a phosphite, a phosphonate, a carboxylate (e.g., sodium stearate, etc.), or a mixture thereof.

In one particular embodiment, the anionic surfactant may include a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C10-C16 alkylbenzene sulfonates, C10-C22 alkane sulfonates, C10-C22 alkyl ether sulfates, C10-C22 alkyl sulfates, C4-C10 dialkylsulfosuccinates, C10-C22 acyl isothionates, alkyl diphenyloxide sulfonates, alkyl naphthalene sulfonates, C10-C20 alpha olefin sulfonates, and 2-acetamido hexadecane sulfonates. In one aspect, the anionic surfactant may include C6-C12 linear and/or branched alkyl sulfates and/or C6-C12 linear and/or branched alkyl ether sulfates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof. In some aspects, the anionic surfactant may include sulfated alkanolamide, glyceride sulfate, or a mixture thereof.

As indicated above, in one embodiment, the surfactant may include a non-ionic surfactant. In one aspect, the nonionic surfactant may be an amine oxide. In one aspect, the nonionic surfactant may be an ethoxylate. For instance, the nonionic surfactant may be an ethoxylated fatty alcohol, a linear alcohol ethoxylate (e.g., narrow-range ethoxylate, octaethylene glycol monododecyl ether, pentaethylene glycol monododecyl ether, etc.), an alkylphenol ethoxylate (e.g., a nonoxynol, octylphenol ethoxylate, etc.), a fatty acid ethoxylate, an ethoxylated fatty ester, or an ethoxylated amine. In some aspects, the nonionic surfactant may be and/or include fatty acid amides (e.g., polyethoxylated tallow amine, cocamide monoethanolamine, cocamide diethanolamine, etc.), fatty acid esters of glycerol (e.g., glycerol monostearate, glyercol monolaurate, etc.), fatty acid esters of sorbitol (e.g., sorbitan monolaurate, sorbitan monostearate, sorbitan tristearate, etc.), alkyl polyglycosides (e.g., decyl glucoside, lauryl glucoside, octyl glucoside, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics). In one embodiment, the surfactant may be a silicon surfactant such as a polyether-modified siloxane.

In one embodiment, the surfactant may include a cationic surfactant. For instance, the surfactant may include a cationic surfactant such as water-soluble quaternary ammonium compounds, polyammonium salts, a polyoxyethylene alkylamine and the like. In some aspects, the surfactant may include a cationic surfactant such as a quaternary ammonium salt (e.g., cetrimonium bromide, cetylpyridinium chloride, benzalkonium chloride, benzethonium chloride, dimethyldioctadecylammonium chloride, and dioctadecyldimethylammonium bromide, etc.).

Notably, the additives of the gypsum slurry, gypsum core, and/or water resistance enhancement composition may include a starch. The starch may be one generally utilized in the art. Such starch may be combined with the stucco and water. In this regard, such starch may be present in the gypsum slurry as well as the resulting gypsum core and gypsum panel. In one aspect, one or more components of a gypsum panel may be free of starch. For instance, the gypsum core and/or gypsum slurry may be free of starch. In one aspect, a gypsum panel formed in accordance with the present disclosure may be free of starch.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more. The gelling temperature may be 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, oxidation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

The manner in which the components (e.g., stucco, gypsum, liquid, water resistance enhancement composition, siloxane composition) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer or pinless mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a crystalline matrix of calcium sulfate dihydrate. In this respect, the stucco may convert into calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal (e.g., evaporation) of any free water. The temperature and time required for drying in a heating device is not necessarily limited by the present invention.

In one embodiment, the gypsum core may include a first gypsum core layer and a second gypsum core layer. The first gypsum core layer may be between the first facing material (e.g., front of the gypsum panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (e.g., back of the gypsum panel). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

The gypsum panel disclosed herein may have many applications. For instance, the gypsum panel may be used as a standalone panel in construction for the preparation of walls, ceilings, floors, roofs, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 50 microns to about 1200 microns, such as about 50 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about 1200 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 15 m²/g, including all increments of 0.01 m²/g therebetween. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, the thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C473-19 and/or ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C473-19 and/or ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and/or ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17 and/or ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

The water absorption of a gypsum panel may be about 20% or less, such as about 15% or less, such as about 12% or less, such as about 10% or less, such as about 9% or less, such as about 8% or less, such as about 7% or less, such as about 6% or less, such as about 5% or less. The water absorption of a gypsum panel may be about 2% or more, such as about 3% or more, such as about 4% or more. Notably, the water absorption of a gypsum panel may be measured via the Water Absorption Test and/or ASTM C473.

The water absorption of a gypsum panel may be determined by obtaining a 10″×10″ section of a gypsum panel that is then weighed and completely immersed in a container with sufficient water to provide an inch of water above the surface of the panel. The temperature of the water in the water container may be maintained at 70° F.+/−2° F. After two hours, the panel is removed from the water and the surfaces and edges of the panel are dabbed with paper towels to soak excess water on the exterior of the panel. Then, the section of the gypsum panel is weighed a second time. The percent increase in the weight of the gypsum panel section as compared to the original weight is the water absorption percent. For example, if the initial weight of the 10″×10″ gypsum panel section is one pound, and the weight after the two-hour submersion is 1.1 pounds, the water absorption of the gypsum panel is 10%.

### EXAMPLES

### Test Methods

Water Absorption Test: A lab gypsum panel measuring 10″×10″ is weighed and completely immersed in a container with sufficient water to provide an inch of water above the surface of the panel. The temperature of the water in the water container is maintained at 70° F.+/−2° F. After two hours, the panel is removed from the water and the surfaces and edges of the panel are dabbed with paper towels to soak excess water on the exterior of the panel. Then, the lab gypsum panel is weighed a second time. The percent increase in the weight of the lab gypsum panel sample as compared to the original weight is the water absorption percent. For example, if the initial weight of the 10″×10″ lab gypsum panel sample is one pound, and the weight after the two-hour submersion is 1.1 pounds, the water absorption of the lab gypsum panel sample is 10%.

pH Test: The pH of a gypsum slurry utilized to form a lab gypsum sample gypsum core of a lab gypsum panel was measured with an Extech PH100 ExStik pH Waterproof Meter. The pH was measured thirty-five seconds after all of the components of the gypsum slurry were combined.

### Example 1

Gypsum panels were made having gypsum cores comprising varying amounts of Portland cement, sodium carbonate, and sodium bicarbonate. The gypsum slurries utilized to form the gypsum cores of each sample were formed with the same amount of water and the same amount of stucco. All of the gypsum panels had a thickness of ⅝ inches and had a paper facing material on either side of the gypsum core. The percentages listed in Table 1 are indicative of the weight percentage of the respective additive based on the weight of stucco utilized to form the gypsum slurry that formed the gypsum core. For instance, each of Samples 1-3 utilized 0.30 wt. % of methyl hydrogen siloxane based on the weight of the stucco used to form the gypsum slurry that formed the gypsum core.

TABLE 1

| | Methyl | | Sodium | | Board | | |
|---|---|---|---|---|---|---|---|
| | Hydrogen | Portland | Bi- | Sodium | Weight | Water | |
| | Siloxane | Cement | carbonate | Carbonate | [lbs/ | Absorption | |
| Sample | [wt. %] | [wt. %] | [wt. %] | [wt. %] | MSF] | [%] | pH |
| 1 | 0.30 | 0.06 | 0.00 | 0.00 | 1767 | 6.7 | 9.7 |
| 2 | 0.30 | 0.00 | 0.46 | 0.00 | 1742 | 5.3 | 8.1 |
| 3 | 0.30 | 0.00 | 0.00 | 0.46 | 1753 | 5.4 | 8.3 |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising:
a gypsum core comprising gypsum, the gypsum core being formed by a gypsum slurry, the gypsum slurry comprising a water resistance enhancement composition and a siloxane composition, the water resistance enhancement composition being an alkali salt, an ammonium salt, or a combination thereof, the siloxane composition being a siloxane, wherein the weight ratio of the water resistance enhancement composition to the siloxane composition in the gypsum slurry is from about 40:1 to about 1:40; and
a first facing material and a second facing material sandwiching the gypsum core.

2. The gypsum panel of claim 1, wherein the water resistance enhancement composition comprises the alkali salt, the alkali salt being an alkali carbonate, an alkali bicarbonate, or a combination thereof.

3. The gypsum panel of claim 2, wherein the alkali salt comprises an alkali carbonate, wherein the alkali carbonate is sodium carbonate.

4. The gypsum panel of claim 2, wherein the alkali salt comprises an alkali bicarbonate, wherein the alkali bicarbonate is sodium bicarbonate.

5. The gypsum panel of claim 1, wherein the water resistance enhancement composition comprises an ammonium salt.

6. The gypsum panel of claim 5, wherein the ammonium salt is ammonium carbonate, ammonium bicarbonate, or a combination thereof.

7. The gypsum panel of claim 1, wherein the gypsum slurry has a pH of less than about 10.

8. The gypsum panel of claim 1, wherein the gypsum slurry has a pH of less than about 9.

9. The gypsum panel of claim 1, wherein the weight ratio of the water resistance enhancement composition to the siloxane composition in the gypsum slurry is from about 20:1 to about 1:20.

10. The gypsum panel of claim 1, wherein the weight ratio of the water resistance enhancement composition to the siloxane composition in the gypsum slurry is from about 10:1 to about 1:5.

11. The gypsum panel of claim 1, wherein the gypsum panel exhibits a water absorption of less than about 10%.

12. The gypsum panel of claim 1, wherein the gypsum panel exhibits a water absorption of less than about 7%.

13. The gypsum panel of claim 1, wherein the water resistance enhancement composition is present in the gypsum slurry in an amount of 3 wt. % or less by weight of the gypsum slurry.

14. The gypsum panel of claim 1, wherein:
the gypsum slurry has a pH of less than about 9;
the weight ratio of the water resistance enhancement composition to the siloxane composition in the gypsum slurry is from about 20:1 to about 1:20; and
the water resistance enhancement composition is present in the gypsum slurry in an amount of 3 wt. % or less by weight of the gypsum slurry.

15. A gypsum panel comprising:
a gypsum core comprising gypsum;
a siloxane composition, the siloxane composition being a siloxane; and
a first facing material and a second facing material sandwiching the gypsum core;
wherein a water resistance enhancement composition is present in or applied to a gypsum slurry, the first facing material, the second facing material, or a combination thereof during a process of making the gypsum panel, the water resistance enhancement composition being an alkali salt, an ammonium salt, or a combination thereof;
wherein the weight ratio of the water resistance enhancement composition to the siloxane composition in the gypsum panel is from about 40:1 to about 1:40.

16. The gypsum panel of claim 15, wherein the water resistance enhancement composition comprises the alkali salt, the alkali salt being an alkali carbonate, an alkali bicarbonate, or a combination thereof.

17. The gypsum panel of claim 16, wherein the alkali salt comprises an alkali carbonate, wherein the alkali carbonate is sodium carbonate.

18. The gypsum panel of claim 16, wherein the alkali salt comprises an alkali bicarbonate, wherein the alkali bicarbonate is sodium bicarbonate.

19. The gypsum panel of claim 15, wherein the water resistance enhancement composition comprises an ammonium salt.

20. The gypsum panel of claim 19, wherein the ammonium salt is an ammonium carbonate, an ammonium bicarbonate, or a combination thereof.

21. The gypsum panel of claim 15, wherein the gypsum slurry has a pH of less than about 9.

22. A method for making a gypsum panel comprising:
providing a first facing material;
depositing a gypsum slurry comprising stucco, water, a water resistance enhancement composition, and a siloxane composition onto the first facing material, the water resistance enhancement composition being an alkali salt, an ammonium salt, or a combination thereof, the weight ratio of the water resistance enhancement composition to the siloxane composition in the gypsum slurry being from about 40:1 to about 1:40;
providing a second facing material on the gypsum slurry; and
allowing the stucco to convert to calcium sulfate dihydrate.
